(19) United States
(12) Patent Application Publication
(10) Pub. No.: US 2014/0048593 A1
(43) Pub. Date: Feb. 20, 2014

(54) SYSTEM AND METHOD FOR TRACKING CHAIN OF CUSTODY IN AUTOMATED DELIVERY SYSTEM IN A HOSPITAL SETTING

(71) Applicant: TRANSLOGIC CORPORATION, Denver, CO (US)

(72) Inventor: Kenneth Michael Hoganson, Aurora, CO (US)

(73) Assignee: TRANSLOGIC CORPORATION, Denver, CO (US)

(21) Appl. No.: 13/938,904

(22) Filed: Jul. 10, 2013

Related U.S. Application Data
(60) Provisional application No. 61/669,871, filed on Jul. 10, 2012.

(51) Int. Cl. G06Q 10/06

(52) U.S. Cl. CPC G06Q 10/06316
USPC 235/376; 206/459.5

(57) ABSTRACT

Provided herein is a system and method for use in generating a chain of custody (COC) record using different machine readable identification systems. Aspects of the presented inventions are directed to an identification device that incorporates a dual mode identification marking or tag that allows the device to be utilized by at least first and second identification systems that utilize differing identification modalities.

### CROSS-REFERENCE

This application claims the benefit of the filing date of U.S. Provisional Application No. 61/669,871 entitled: “SYSTEM AND METHOD FOR TRACKING CHAIN OF CUSTODY IN AUTOMATED DELIVERY SYSTEM IN A HOSPITAL SETTING” and having a filing date of Jul. 10, 2012, the entire contents of which are incorporated herein by reference.

### FIELD

The present invention relates generally to the field of chain of custody tracking of laboratory samples, pharmaceuticals and other objects (e.g., generally ‘items’) transported in a medical or healthcare facility. More specifically, a system and method is provided that allows tracking items in a hospital setting using first and second machine readable identification means.

### BACKGROUND

In many settings, it is important to monitor and record (e.g., track) the location and possession of items as they are transported from a first location (e.g., origination location) to a second location (e.g., destination location). Generally, such tracking is referred to as a ‘chain of custody’. A chain of custody record typically identifies the location, transfer, and security of an item from origination of the item to disposal or delivery of the item.

Chain of custody records are commonly utilized in hospital and healthcare environments due to the nature of items handled by in these environments. For instance, hospitals often transport controlled substances and laboratory specimens between a pharmacy or lab and intended recipients (e.g., doctors, patients, etc.). As will be appreciated, there are legal ramification associated with a number of procedures performed by a laboratory. This is especially true when the results of a laboratory test may be used in criminal proceedings or to deny employment to an individual. Accordingly, chain of custody procedures are often implemented intended to ensure that a specimen (potential evidence) is kept secure at all times and will stand up to the documentation requirements that may be associated with a legal challenge. Likewise, some items transported within a hospital setting are limited to authorized recipients and/or are subject to pilfering. For example, pharmaceutical/drug delivery transactions may be subject to unauthorized diversion during transport between an origination location and a destination location. Additionally, transactions may contain monetary or confidential/privileged information the receipt of which should be limited to authorized recipients. In all of these instances, chain of custody procedures may be implemented to tack the location and possession of items to withstand legal challenges and/or reduce the likelihood of diversion.

Historically, chain of custody has been recorded via signed documentation that identifies the location, transfer, and security of an item from origination to delivery/disposal and provides documentation that identifies each person having true possession of the transferred item. Such procedures originally included documents that were signed by each person handling the item. However, with the rapid assimilation of machine readable identifiers into modern facilities, much of the chain of custody documentation has been replaced by entries generated by identification systems that identify items via machine readable codes. For instance, many if not most hospitals utilize bar codes to track items within a facility. Such systems have reduced the work load of those responsible for tacking items in these settings.

### SUMMARY

Aspects of the presented inventions are based in part on the realization by the inventor that in many healthcare settings, multiple identification systems are utilized simultaneously and that currently, there is no way to bridge the information between these systems. For instance, while it is common to utilize bar codes in hospital setting to, among other things, match drugs to patients, it is also common to deliver drugs and other items using automated delivery systems. Such automated delivery systems include, without limitation, pneumatic transport systems, automated guide vehicles, electric track vehicles and/or mobile robotic delivery devices. Generally, such automated delivery systems utilize a carrier unit that moves about a facility to deliver items between locations. While these automated delivery systems can, in some instances, incorporate bar code readers to identify items accepted by the system. These systems are generally unable to automatically identify and record the items deposited within the carrier units of the transport system. Further, the inventor has recognized that many automated delivery systems utilize proximity identification devices that allow for identifying the location of their carrier units by the proximity of that carrier unit to location sensors located throughout a facility. In one specific non-limiting example, many pneumatic tube transport systems incorporate radio frequency identification devices (RFID) that allow for monitoring and tracking the carriers of the pneumatic tube transport system as these carriers proceed through a facility.

While such automated delivery systems often have the ability to monitor the location of their carrier units as they proceed though a facility, there is currently no way to readily tie the location information of the delivery system to the items carried by the delivery system. This is due to several factors including the fact that most automated delivery systems operate independent of other systems in a facility. For instance, in a hospital setting, patient and pharmacy records are separate from the routing and control systems of the automated carrier systems. Further, these systems generally utilize different machine reading technologies (i.e., different identification modalities).

To account for differing modalities identification systems, aspects of the presented inventions are directed to an identification device that incorporates a dual mode identification marking or tag that allows the device to be utilized by at least first and second identification systems that utilize differing identification modalities.

According to a first aspect, a system, apparatus and method for use (i.e., utility) is provided for use in transporting items in a chain-of-custody tracking system. A utility includes an identification container having an interior area sized to receive an item. In this regard, an item for which COC tracking is desired may be secured within an interior area the container. The container further includes a first machine readable identification tag attached to an external surface of the container. This first machine readable identification tag includes a first code identifying the first identification tag. Further, this first code is readable by a first machine reading device utilizing a first machine reading technology. A second machine readable identification tag is also attached to an external surface of the container. This second machine readable identification tag includes a second code identifying the second machine readable identification tag and is readable by a second machine reading device utilizing a second machine reading technology, which is different from the first machine reading technology. Furthermore, the first code is derivable from the second code. In this regard, the first and second codes may be identical such that if the second code is known, the first code is known. In a further arrangement, the first code and second code may be correlated within an electronic record or look-up table.

The first and second machine readable code may utilize any appropriate technology. By way of example, and not limitation, machine readable mediums may include bar codes, magnetic codes, RFID codes, etc. In this regard, the machine readable technologies may include magnetic, optical, and/or electromagnetic reading technologies. Furthermore, while the first and second machine readable codes are different, it will be appreciated that two types of a common machine readable technology may be utilized. For instance, first and second different types of bar codes may be utilized. Alternatively, first and second types of RFID identifications may be utilized. For instance, a first RFID identification tag may utilize a first frequency, and a second RFID identification tag may utilize a second frequency. In this regard, the respective RFID tags may be read by different interrogators utilizing separate frequencies or by a common interrogator that is capable of utilizing multiple frequencies. In one arrangement, one of the machine readable identification tags is a bar code and the second machine readable identification tag is an RFID tag.

According to another aspect, a system and method (i.e., utility) is provided for generating a chain of custody record for an item transported in a hospital setting. The utility includes attaching a tag to an item where the tag has first and second machine readable identification elements. These first and second machine readable elements are adapted to be read by first and second different machine reading technologies. Further, attaching the tag to the item may include disposing the item within an identification container onto which the identification tags are attached. The utility further includes generating an electronic record indexed to a code associated with one of the first and second identification tags. Further, upon initially generating or moving the item, the first machine readable identification tag may be read using a first machine reading technology and a first data entry may be made to the database record that is indexed to this code. Upon a subsequent movement of the item, the second machine readable identification tag may be read utilizing a second machine reading technology. Based on a second code obtained from the second identification tag, an additional transaction record may be stored to the database record that is indexed to the first read code. Generating the second data entry may require correlating the first and second codes to identify an appropriate record.

According to another aspect, a system is provided for generating a chain-of-custody record for an item transported in a hospital setting where a portion of the transport is performed utilizing an automated transport system. The system includes a first identification system that is configured to receive input from optical readers. This system further includes a database that is configured to receive input from the first identification system and store at least a first data entry indexed to a first data code read from an optical code element on an item. The system also includes an automated transport system having a second identification system that is configured to receive input from a proximity identification device. The proximity identification device is configured to identify a second code from a proximity code element disposed on the item, which also includes the first optical code. A correlation module is adapted to correlate the second code received from the second identification system with the first code received from the first identification system. Further, the database is configured to store at least a second data entry indexed to the first code upon correlating the second code with the first code. Stated otherwise, data entries may be generated in a common record upon reading different identification elements using the proximity identification system and/or the optical identification system.

In one arrangement, the automated transport system includes a pneumatic tube transport system that has multiple stations interconnected via pneumatic tubing throughout a facility. The pneumatic tube system further includes a radio frequency identification system that is operative to identify locations of carriers as they pass through the system via radio frequency identification. In such an arrangement, the second identification system is an RFID system that allows for proximity sensing of an item containing an RFID tag.

In one arrangement, the system further includes a code generator that is adapted to generate the first code for use with the first identification system and a second code for use with the second identification system. In this arrangement, the code generator is operative to store the first and second codes to a record such that the relationship or correlation between these codes is known and may be utilized at a later time to relate one code to the other.

In a further arrangement, the system includes a printer that is configured to print a tag for attachment to an identification container. This printer may be adapted to print an optical code on a tag that includes an RFID element. In a further arrangement, the printer is adapted to print both an optical code and an RFID element on the tag.

### BRIEF DESCRIPTION OF THE DRAWINGS

FIG. 1 illustrates one embodiment of a COC procedure using a bar code scanning system.

FIG. 2 illustrates a mechanical diagram for a pneumatic carrier system.

FIG. 3 illustrates a system diagram for the operation and monitoring of the pneumatic carrier system.

FIG. 4 illustrates a view of the pneumatic carrier including an identification chip.

FIG. 5 illustrates a dual identification tag having first and second machine readable elements.

FIG. 6 illustrates a system the utilizes first and second identification systems to generate a COC record in conjunction with transport via an automated delivery system.

FIG. 7 illustrates a dual identification tracking container.

FIG. 8 illustrates a process for use in generating a COC record using at least two identification systems.

### DETAILED DESCRIPTION

Reference will now be made to the accompanying drawings, which assist in illustrating the various pertinent features of the various novel aspects of the present disclosure. Although the inventions are described primarily with respect to chain of custody monitoring of items in a healthcare settings, the inventions are applicable to a broad range of material handling applications. In this regard, the following description is presented for purposes of illustration and description. Furthermore, the description is not intended to limit the inventions to the forms disclosed herein. Consequently, variations and modifications commensurate with the following teachings, and skill and knowledge of the relevant art, are within the scope of the present invention.

As utilized in this application, terms “component,” “object,” “module,” “system,” “controller,” “device,” “interface,” “middleware” and variants thereof are intended to refer to a computer-related entities, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. Additionally, it is noted that printing of a barcode Identification Tag and/or printing of a Radio Frequency Identification (RFID) tag and programming of an RFID tag can be understood a common processes or separate processes directed to the creation, assembly, encoding, and/or production of one or more identification tags.

Chain of custody (COC) refers to a chronological documentation or paper trail, showing the acquisition, custody, control, transfer, analysis, and disposition of an item. In the context of the legal system, COC is important in the acquisition of evidence, physical or electronic. Because evidence can be used in court to convict persons of crimes, it must be handled in a scrupulously careful manner to avoid later allegations of tampering or misconduct. However, COC also has importance in other settings. For instance, the delivery and administration of pharmaceuticals/drugs in hospital settings is also subject to chain of custody procedures.

Establishing a chain of custody record is a chronological and logical procedure. An identifiable person or secured location must always have the physical custody of a COC item. In practice this means that an individual will take charge of an item, document its collection or production, and hand it over to a second person for delivery or storage in a secure location. These transactions, and every succeeding transaction between the collection or production of the item and its final disposition (e.g., administration), should be completely documented chronologically. Documentation should include the conditions under which the item is obtained, the identity of all individuals who handle the item, duration and location of storage, and the time or location when the item transferred to subsequent individuals. In order to provide COC, many health care facilities have incorporated bar code tracking technologies. Such bar codes providing a tracking code that is computer generated utilizing a time stamp and item (e.g., drug) identification information. Each activity in which the item subsequently participates, e.g., preparation, inventory, delivery, dispensing, administration, return, charge or credit, etc., will be recorded and related to the unique tracking code. The tracking code enables tracking of events pertaining to a specific item as it proceeds though a facility. Each time the item is transferred the bar code is scanned (or information is manually entered into a record) and a database entry is created in a record relating the item to the bar code. Relating the database entries via the bar code enables a specific item to be tracked.

Bar codes are readily readable by optical scanners such as a handheld scanning devices. The tracking code may also be represented by human and machine readable alpha and numeric numbers and characters, as well as combinations thereof. The tracking code can be used for tracking all activities relating to a specific item or drug, for example, drug preparation, patient data, physician and pharmacist identification, diagnosis, date, drug inventory, drug dispensing, drug administration, drug return, drug credit or charge, etc. Likewise, the bar code can be associated with an electronic information and data record that relates the patient to the specific medication and drug database.

In the case of drug preparation and delivery, encoding of the drug typically takes place in a pharmacy where a printed label containing the bar code is applied to a container holding the drug (e.g., pill bottle, IV bag etc.). In addition to the bar code, other information may be provided on the label. For example, the additional information can provide direct identification of drug name, drug concentration, patient name, hospital billing information, pharmacist's name, date of filling the drug order, drug administration information, etc. This additional information may also recorded in a database record indexed to the bar code.

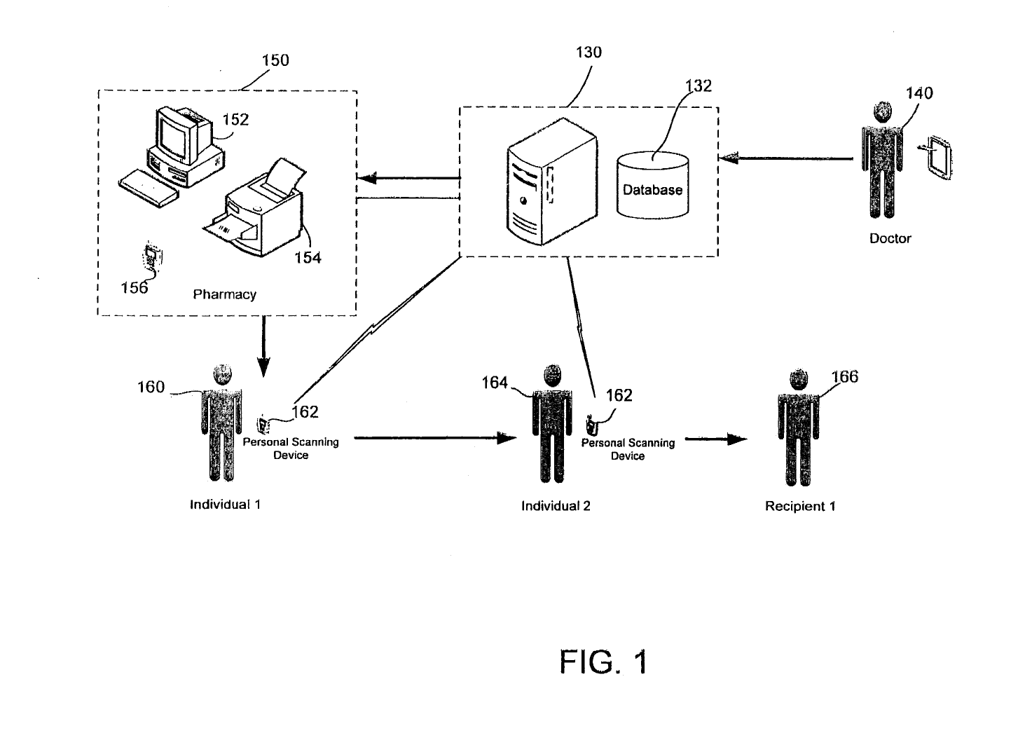

Referring to FIG. 1, there is diagrammatically illustrated a network system as one example of one application of the use of a bar code in a hospital/healthcare environment to generate a COC record. The network system is centered around a data base server 130 and database 132 for the storage and retrieval of information and data received and accessed from multiple locations. A physician or other health care professional 140, after ascertaining the need for one or more drugs, places an order for the same by any suitable means with a pharmacy 150. The prescription is filled at a pharmacy work station which includes a printer 154 (e.g., a bar code label printer) and a bar code scanner 156 which are connected to a user work station such as desktop computer 152. In further arrangements, the preparation of the drug may be automated.

The bar coded label may be scanned using the bar code scanner 156 to associate the bar code with specific patient information stored on the data base server 130 which may be entered by the pharmacists, physician or other hospital personnel. Similarly, drug information such as drug name, concentration, time of preparation, etc. can also be associated with the bar code by entering same into the data base server 130 under the bar code.

The labeled item may delivered to a location of drug administration, for example, patient rooms, operating rooms or to drug storage locations. In this regard, a first individual 160 transporting the item typically scans the bar code using a scanning device 162 recoding the transfer to from the pharmacy to the individual 162. This scanning process typically records the identification of the individual 160 and time of receipt of the item to the database COC record. Likewise, if this first individual delivers the drug to a second individual 164 (e.g., nurse who administers the drug) the bar code is again scanned to record the subsequent transfer and location of the drug. The bar code may again be scanned when the item is delivered to an end user or recipient 166 (e.g., patient).

In this example, a record is generated that identifies the chain of custody of the drug from its preparation through its delivery. Further, each individual who handles the drug, may scan the barcode and/or enter additional information (e.g., identification of individual) that is recorded to the database record. This information may be entered by means of the computer, scanner or any other suitable data input device and may be entered automatically or manually. For instance, a receiving individual may scan their own bar code (e.g., employee badge) in conjunction with scanning the bar code of the item. The result is that an audit trail is created for the item.

While providing a workable method for creating a COC record or audit record for an item, the above noted process suffers from various inefficiencies in practice. One specific drawback is that in large medical facilities, distances between origination locations such as pharmacies, labs or supply facilities and destination location such as nurse stations, patient rooms, operating rooms etc., are often quite large. In such facilities, it is common to transport items between such locations using automated delivery systems. Such automated delivery systems include, without limitation, pneumatic transport systems, automated guide vehicles, electric track vehicles and/or mobile robotic delivery devices. Generally, such automated delivery systems utilize a carrier units that moves about a facility to deliver items between locations.

Automated delivery systems can, in some instances, incorporate bar code readers to identify items accepted by the system if an individual who deposits the item with the automated delivery system scans the item into the system. However, these automated delivery systems are generally unable to automatically read the identification code of items deposited within the carrier units of the delivery system. That is, no line-of-sight exists to read the bar code automatically. Further, experience has shown that system users often neglect to scan items into the system and instead just enter delivery information (e.g., destination information) for the item. In such arrangements, an item that requires chain of custody documentation may have no documented location information between the time the automated delivery system acquires an item and the time when the automated delivery system delivers the item. That is, once an item is deposited with the automated system, the system is generally unable to read an identification means of the item during transport. Accordingly, if the item is diverted prior to its intended destination, the location of diversion may not be known. Further, the location of the item during the delivery process may not be documented. That is, all that is known is that the item was deposited with the automated delivery system and later was delivered; there is no information on the whereabouts of the item during the delivery process. This is problematic as some automated delivery systems are operative to securely hold and store items for delayed delivery (e.g., overnight). One exemplary automated storage system that stores received items between receipt and delivery is set forth in U.S. patent application Ser. No. 12/574,863 entitled “Pneumatic Transport Delivery Control” the contents of which are incorporated herein by reference. Further, the path the item takes during delivery may vary based on dynamic routing abilities of the automated delivery system.

In order to successfully route carrier units though a facility, it is common that automated delivery systems utilize proximity identification devices that allow for identifying the location of carrier units as they proceed through the facility. In one specific non-limiting example, some pneumatic tube transport systems incorporate radio frequency identification devices (RFID) that allow for monitoring and tracking the pneumatic carriers of the delivery system as they proceed through the pneumatic tubing connecting different locations of a facility.

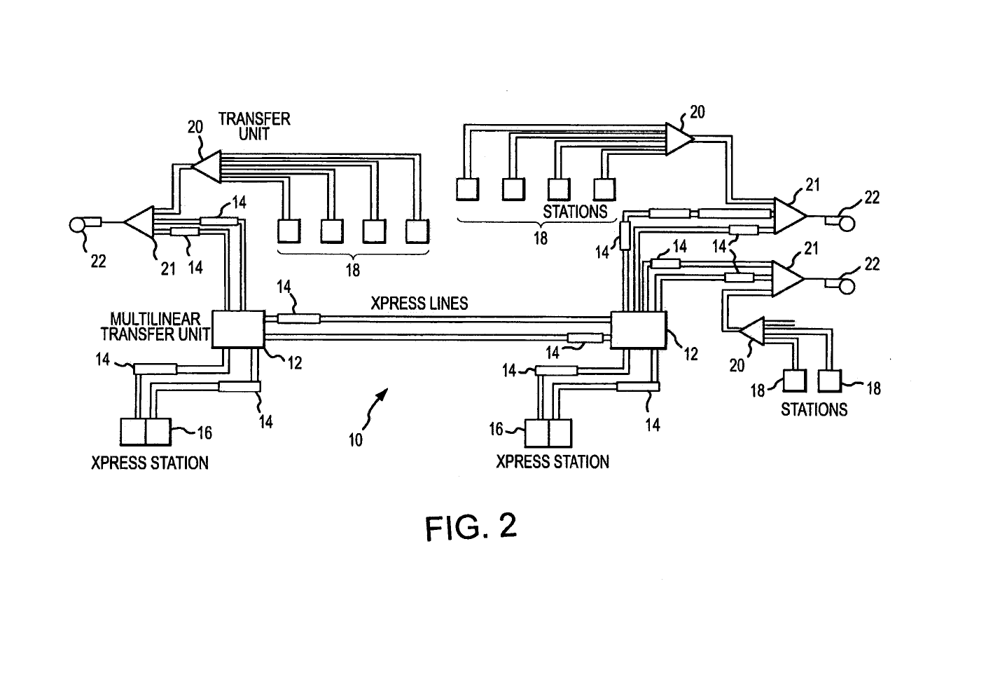

Disclosed in FIG. 2 is a system diagram for an exemplary automated delivery system which in the present embodiment is represented by a pneumatic carrier system 10. In general, the pneumatic carrier system 10 transports pneumatic carriers between various user stations 16, 18, each such transport operation being referred to herein as a “transaction”. At each of the user stations 16, 18, a user may place an item within a carrier, insert the carrier into a carrier dispatcher of the station and select/enter a destination address/identification, and then send the carrier. The system determines path to route the carrier and begins directing the carrier through the system.

To effect delivery through the system transfer units 20 are connected with each station 16, 18 that arrange carriers arriving through different tubes from a different stations 16, 18 into a single pneumatic tube. This pneumatic tube is further in connection with a vacuum by-pass transfer unit 21 (i.e., turn around transfer unit) and a blower 22 that provides the driving pneumatic force for container movement.

Within the system 10 itself, one or more devices are employable for ordering and routing carriers to their selected destinations. One type of device is a traffic control unit (TCU) 14 which is employable to receive, temporarily store and release a number of carriers. Also included in the system 10 are multi-linear transfer units (MTUs) 12 which have functionality to direct carriers from one pneumatic tube to another. Other routing devices may be incorporated into the system as well.

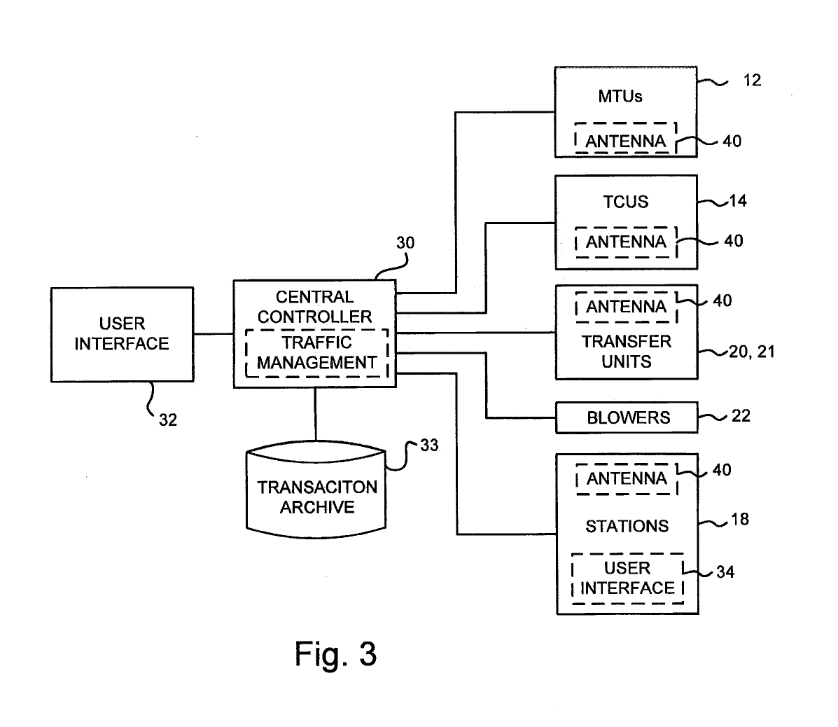

All of the components described in FIG. 2 are electronically connected to a central controller which controls their operation. Disclosed in FIG. 3 is an electrical system diagram for the pneumatic carrier system 10. Providing centralized control for the entire pneumatic carrier system 10 is a system central controller (SCC) 30. The SCC 30 may include a digital processor and memory. Connectable to the SCC 30 may be one or more user interfaces 32 through which a system user may monitor the operations of the system and/or manually enter one or more commands to control its operation.

In the present embodiment, incorporated into each of the user stations 16, 18, transfer units 20, 21, MTUs 12 and TCUs 14 and/or pneumatic tubes connecting these system components is at least one antenna device/reader 40 configured to energize and retrieve identification information from proximity identification devices such as RFID chips incorporated into each carrier. In other arrangements, the reader may be a magnetic reader that reads magnetic ID devices attached to the carriers. These antenna/readers allow for tracking and recoding the movement of the carriers moving through the system. A pneumatic system incorporating such tracking capabilities is disclosed in U.S. Pat. No. 7,243,002 the entire contents of which are incorporated herein by reference.

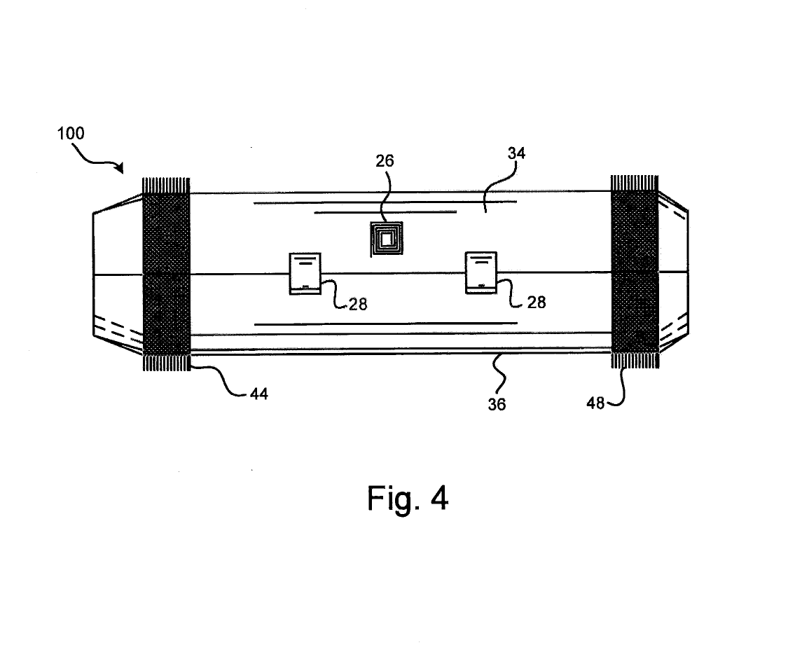

Disclosed in the FIG. 4 is a view of a pneumatic system carrier 100 which includes at least one identification device, or, as shown ID chip 26. Though shown as a small, integrated chip, it will be appreciated that other identification devices may be used and that the configuration and location of the identification device may vary. For instance, the identification device may be formed as a band disposed about the circumference of the carrier 100 to allow reading the identification device by an antenna device/reader 40 irrespective of the orientation of the carrier 100. In a typical carrier, the carrier 100 includes first and second shell members 34 and 36 which are adjoinably cylindrical in cross-section for use in correspondingly cylindrical tubes of the system 10. The shell members 34 and 36 may be pivotably interconnected by a hinge member (not shown), and latches 28 may be provided for securing the first shell member to the second shell member in a closed configuration. Also included as part of the carrier 100 are wear bands 44, 48.

Incorporated into one each of the carriers utilized by the system is an RFID chip 26. This RFID chip 26 is configured to store and provide access to identification information written thereon. In one configuration of the system, the RFID chip 26 may be a read-only chip. That is, an antenna device 40 may only read information off the RFID chip 26. Typically, these types of RFID chips 26, or tags, are sequentially numbered at a production facility to ensure that the customer gets tags with truly unique numbers. Alternatively, RFID chips 26 may be provided so that an antenna 40 may write information to the ID chips 26 as well as read data therefrom. For example, information corresponding with an origination station, time of departure, intended destination station, actual destination station and/or time of arrival may be written into the RFID chips 26. Further, the identity of a person who has performed a certain operation in relation to a transported material can be written to the corresponding RFID chip 26 along with the date and time the action was performed.

When a carrier moves from a first station 16, 18 to a second station 16, 18, information can be read off the RFID chip 26 and sent to the SCC 30 (e.g., for storage in a transaction record). In some instances, the RFID chips 26 may be read while the carrier 100 is in motion (i.e., on the fly). In any case, when the RFID chips 26 is read, an entry can be made in the database record indexed to an identification code of the RFID chip. Such a record may include where the carrier was when the RFID chip 26 was read and/or the time when the RFID chip 26 was read.

Returning again to the electrical system diagram of FIG. 3, it may be seen that the SCC 30 is further connectable to a transaction archive 42, or database, which is configured to store transaction information for carriers 100 moving within the system 10. The transaction information may include identification information for carriers 100 moving through the system and destination information entered by a system user. Further, the transaction information may include location information obtained via tracking inputs received from antenna devices/readers 40 located at user stations 16, 18, TCUs 12, MTUs 16 and/or pneumatic tubes along the travel path of a given carrier 100.

In operation, the antenna devices/readers 40 positioned throughout the pneumatic carrier system identify carriers 100 as they pass from one location to another. Generally, when a carrier 100 is to be employed for carrying an item from an origination station 16, 18 to a destination station 16, 18, the carrier may be identified using the antenna device/reader 40 at the origination station 16, 18. Once a destination is selected for the particular carrier 100, the identification information may be associated with the path calculated for the carrier 100 through the pneumatic carrier system 10 and the destination. This information may be stored in a data entry (e.g., transaction record) within the transaction archive 42. As the carrier 100 moves from one location to another, the antenna device/reader 40 at the various locations will energize the ID chip 29 and extract the identification information. Once a carrier 100 reaches a destination, the ID chip 29 information may then be confirmed against transactions that are intended to be received at the particular destination. Additionally, upon arrival at a destination, a confirmation may be provided to the origination station. In this regard, a record tracking the progress of a carrier form origination to destination may be generated.

While automated delivery systems often have the ability to monitor the location of their carrier units as they proceed though a facility, there is currently no way to readily tie the tracking/location information of the delivery system to the items carried by the delivery system. This is due to several factors including the fact that most automated delivery systems operate independent of other systems in a facility. For instance, in a hospital setting, patient and pharmacy records are typically separate from the routing and control systems of the automated carrier systems. Further, once an item is placed within a carrier unit, the automated delivery system cannot read the machine readable identification element of the item. In one specific arrangement, a bar code applied to an item cannot be read once placed within a pneumatic carrier in a pneumatic tube system. Further, it is common that a hospital inventory system and an automated transport system utilize different machine readable identification technologies. That is, bar codes have become the primary method of tracking items within a hospital setting and proximity sensors such as RFID tags have become the primary means for use in tracking and controlling carrier units of automated delivery systems and these systems (barcode and RFID) utilize different identification technologies.

As will be appreciated, barcodes are optical machine-readable representations of data. Originally barcodes represented data by varying the widths and spacings of parallel lines, and may be referred to as linear or one-dimensional (1D). Later barcodes evolved into rectangles, dots, hexagons and other geometric patterns in two dimensions (2D). Although 2D systems use a variety of symbols, they are generally referred to as barcodes as well. Barcodes are scanned by special optical scanners called barcode readers though other scanning devices and interpretive software has become available on devices including dedicated handheld scanners, desktop printers and smartphones.

The data in a bar code is a reference number which a computer uses to look up associated computer record(s) which contain descriptive data and other pertinent information. That is, the bar codes themselves do not contain any secondary information. Rather the bar code has an “identification number”. When read by a bar code reader/scanner and transmitted to the server/computer, the computer finds record(s) associated with that identification number. This contains all secondary information associated with the bar code. Thus, the computer does a “lookup” by reading the bar code, and the obtaining information from one or more records that are associated with the bar code. Stated otherwise, bar codes typically have only ID data that is used by a computer to look up all the pertinent detailed data associated with the ID data.

Radio-frequency identification (RFID) is the use of a wireless non-contact system that uses radio-frequency electromagnetic fields to transfer data from a tag attached to an object. Some tags require no battery and are powered by the electromagnetic fields used to read them. Others use a local power source and emit radio waves (electromagnetic radiation at radio frequencies). The tag contains electronically stored information which can be read from up to several meters away depending upon the power of the system interrogating the tag. Unlike a bar code, the tag does not need to be within line of sight of the reader and may be embedded in a tracked object.

A radio-frequency identification system uses RFID tags, or labels attached to the objects to be identified. Two-way radio transmitter-receivers called interrogators or readers send a signal to the tag and read its response. The readers generally transmit their observations to a computer system running RFID software or RFID middleware. The tag's information is stored electronically in a non-volatile memory and the RFID tag includes a small RF transmitter and receiver. Often such RFID tags are formed of solid state circuitry. However, the circuit defining the RF transmitter and receiver can be printed.

An RFID reader or interrogator transmits an encoded radio signal to interrogate the tag. The tag receives the message and responds with its identification information. This may be only a unique tag serial number, or may be include additional specific information. By way of example, an Electronic Product Code (EPC) is one common type of data stored in an RFID tag. When written into the tag by an RFID printer, the tag contains a 96-bit string of data. The first eight bits are a header which identifies the version of the protocol. The next 28 bits identify the organization that manages the data for this tag; the organization number is assigned by the EPCGlobal consortium. The next 24 bits are an object class, identifying the kind of product; the last 36 bits are a unique serial number for a particular tag. These last two fields are set by the organization that issued the tag. Rather like a URL, the total electronic code number can be used as a key into a global database to uniquely identify a particular item. While providing an example of the data that may be incorporated into an RFID tag, it will be appreciated that the various data fields of an RFID tag may be modified for a particular purpose.

As noted above, each of the machine reading technologies (i.e., bar code reading and RFID reading) allows for extracting at least one identification code from a related identification element. However, these systems are incompatible with one another. That is, the bar code scanning system cannot read RFID tags, and the RFID system cannot read bar codes. Accordingly, these systems are incompatible with one another and an item that is being tracked by a bar code cannot be identified and tracked by an RFID system. To account for the use of different machine readable technologies, aspects of the presented inventions are directed to a dual identification system that utilizes a tracking device that incorporates a first identification element that is readable by a first machine readable technology, and a second identification element that is readable by a second machine readable technology, where the first and second technologies are different.

In one embodiment, an RFID tag is encoded to contain the identification code that is related to a bar code that is also attached to the tracking container. IN this regard, when the RFID tag is interrogated by an RFID reader or antenna, the bar code identification code is obtained. Accordingly, information may be stored in the record associated with the barcode record. For instance, when a pneumatic carrier is interrogated within a pneumatic tube system, the barcode record may be updated to identify the time the RFID tag was interrogated and the location of the carrier when it was interrogated. In this latter regard, it will be appreciated that each of the RFID interrogators may have a known location or location code associated therewith. When the RFID tag is read, the barcode record may be accessed and the location of the carrier in the pneumatic system at the time of interrogation may be written to the bar code record. Thus, the system is able to utilize first and second machine readable identification systems to track an item as it transits though a facility. Stated otherwise, a more complete COC record may be generated that tracks an item from its origination through its delivery.

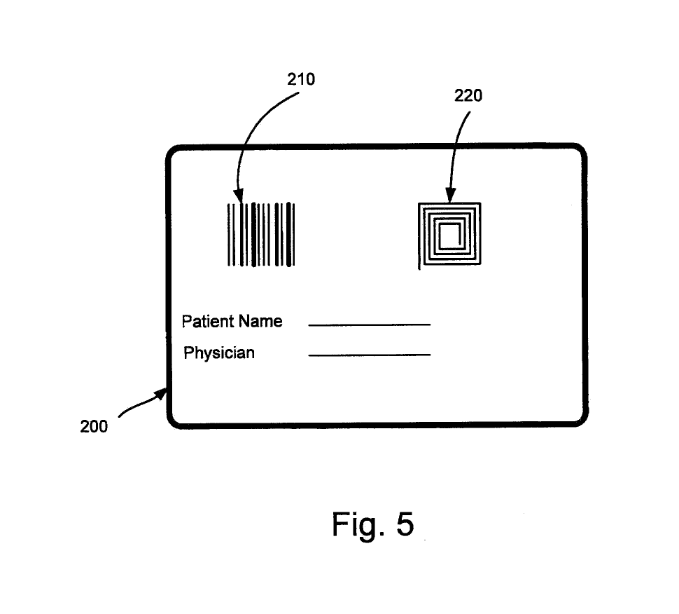

FIG. 5 illustrates a tracking tag 200 that utilizes a dual identification element. Specifically, the tag 200 includes a first machine-readable code, which in this embodiment is a bar code 210, and a second machine readable element, which in this embodiment is an RFID tag 220. This tag 200 allows an item, to which the tag 200 is attached, to be tracked utilizing either a bar code scanning system or an RFID system.

In order to provide tracking capabilities utilizing either machine readable identification technology (e.g., bar code or RFID), the identification codes of the bar code 210 and the RFID element 220 need to be correlated. That is, the codes of these elements 210, 220 must be related in a known manner such that a single tracking record may be updated based on the identification of either of the codes of these elements 210, 220.

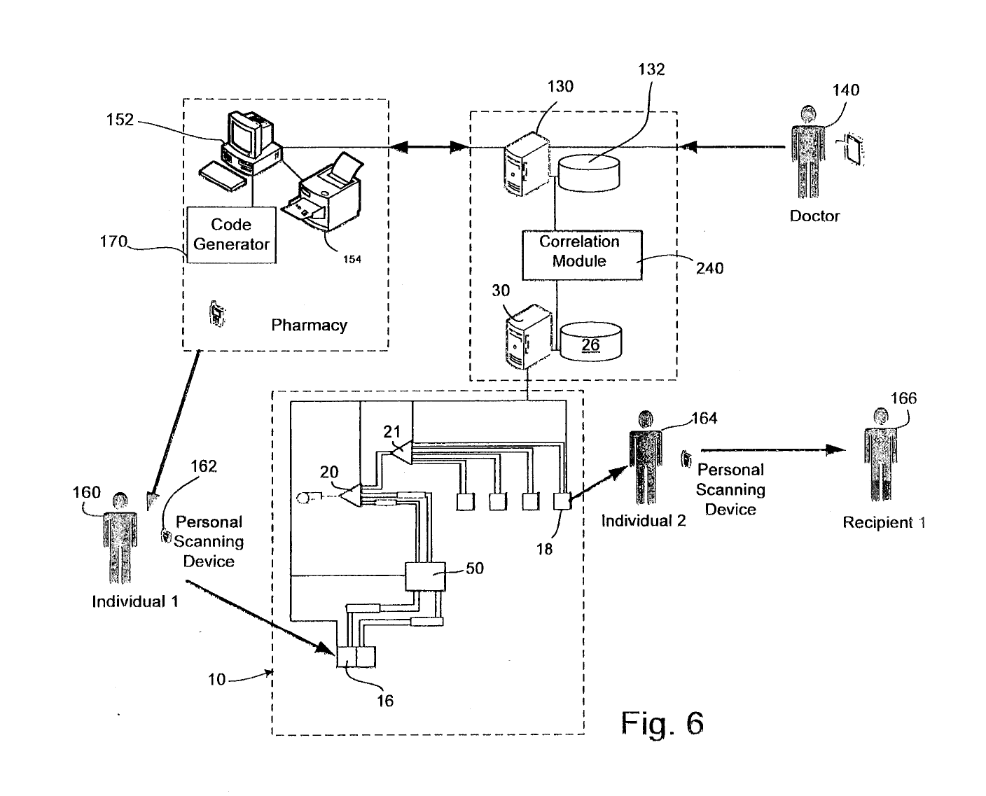

FIG. 6 illustrates an integrated tracking system for use in a hospital setting. As illustrated, the tracking system utilizes both an optical scanning system (e.g., bar code reading system) and a proximity sensing system (RFID system) to track a component from generation through delivery where the item passes through an automated delivery system, which in the present embodiment is represented by a pneumatic tube system 10. In a COC process similar to that described in relation to FIG. 1, initially, a health care professional 140 requests a drug or other item from a pharmacy 150. Initially, the doctor generates a request which is received by a network server 130, which records the request in a record in a database 132. This record may be appended to, for example, a patient name or identification number. This order is then forwarded to the pharmacy 150, where pharmacists or other technicians fill the order. In conjunction with filling the order, the pharmacy technicians may enter information into a user workstation 152. In the present embodiment, the workstation 152 is interconnected to a printer 154 which is adapted to generate the tag 200 discussed in relation to FIG. 5.

Incorporated within the user workstation or the network server 130 is a code generator 170. The code generator 170 is adapted to generate a bar code 210 for attachment to the item requested by the physician 140. This bar code may relate to a patient name or identification number. That is, the bar code may be identical to a patient identification number, or may be a new code that is related to patient identification and records. In addition, the code generator is adapted to generate a code for the RFID element 210. This RFID code may be identical to the bar code, or may be a separate code. In the later regard, the code generator may provide the bar code and the RFID code to a correlation module 240 associated to the network server. In this regard, a record is generated that identifies the relationship between the two codes.

The printer 154 may generate the tag 200, including the first and second codes for the first and second elements 210, 220. In such an arrangement, the printer 154 may be adapted to print bar codes onto tags that include a pre-generated RFID element. In such an arrangement, the printer 154 may be further operative to write codes to the RFID element 220. Alternatively, if the RFID elements include pre-written codes, the code generator 170 may be adapted to obtain this code from the printer 154 and relate it to the bar code generated for the ordered item. In a further arrangement, the printer 154 is adapted to print both the bar code element 210 and the RFID element 220. In this regard, it will be appreciated that recent advances in RFID technology allow for the printing of circuits that enable RFID capabilities. In this regard, magnetic inks may be utilized to print a circuit that is adapted to store data, receive interrogation signals, derive energy from an interrogation signal (e.g., rectify received energy) and transmit a response signal. Once the tag is generated, it may be attached to an item or a container that holds an item for subsequent transport to a recipient.

Once the tag 200 is generated and attached to an item, the pharmacy technician may scan the tag, e.g., utilizing a bar code reader. At this time, the bar code is read and a COC record within the database 132 is generated or updated to indicate the item has is ready for transport to a patient. In the illustrated embodiment, a first individual 160 delivers the tagged item to an automated transport system 10. Again, this first individual 160 may scan the bar code utilizing a personal scanning device 162 to identify they have possession of the item and are moving the item from the pharmacy 150 to the automated delivery system 10. However, it will be appreciated in other embodiments the technician or pharmacist generating the item may deliver the item to the automated delivery system 10.

In the present embodiment, where the automated delivery system is a pneumatic tube system 10, delivery of the item to the pneumatic tube system may, include disposition of the item within a carrier that is adapted for use within the pneumatic tube system 10. In this embodiment, once the item is disposed within the carrier, the carrier may be delivered to a first user station 16. The user may then select a destination location (e.g., a second user station 18) and launch the carrier into the pneumatic tube system. In the present embodiment, the pneumatic tube system 10 incorporates an RFID identification system that allows for interrogating the carriers that are placed in and pass through the system. In addition, these interrogators are operative to energize the RFID element 220 interconnected to the tag that is attached to the item. The interrogator may utilize a common frequency to interrogate the RFID tag of the carrier and the RFID tag 220 of the item or the interrogator may utilize different frequencies. Accordingly, once the carrier and included item are received by the user station 16, the user station interrogates the RFID tag and sends information, including the time of interrogation and location of interrogation to the central controller 30 of the pneumatic tube system 10. The central controller 30 may generate a transaction record which is stored to the archive 26.

In addition, this information may be sent to the correlation module 240. The correlation module is operative to access stored records that identify the relationship between the RFID code that is obtained from the tag 200 attached to the item within the pneumatic carrier. The correlation module 240 utilizes this identification information to access a COC record (e.g., indexed to the bar code and/or patient identification) such location of the item may be stored to the COC record within the database 132. In the present embodiment, the carrier moves from the first user station 16 to an intermediate storage location 50. This intermediate storage location 50 may again energize the RFID tag on item contained within the carrier such that the time the item is received by the intermediate storage location may be recorded to the COC record. In various arrangements, the carrier and item contained therein may be held within the intermediate storage location 50 until a predetermined time or until an authorized individual who is to receive the item indicates availability. For instance, a nurse may receive a message indicating that a carrier is slated for delivery and that the carrier includes a restricted item(s) (e.g., narcotics). Accordingly, the second individual 164 may enter appropriate codes into a user interface (e.g., located at the second user station 18) to effectuate delivery from the intermediate storage location 50. Accordingly, the carrier may be removed from the intermediate storage location, the RFID tag 220 may be read and the COC record updated indicating the time of removal from the intermediate storage location and the carrier may be routed to the second user station 18. In the present embodiment, such routing may include passing through a bypass transfer unit 21 and transfer unit 20 as the carrier progresses to and is received by the second user station 18. At each of these locations, and/or at locations in between, the RFID tag 220 may be energized by interrogators that allow for proximity reading of the carrier and/or RFID tags contained within the carrier. Likewise, additional entries may be made to the COC record.

Once the carrier arrives at the second user station 18, the second individual may remove the item from the carrier. Again, this individual may scan the bar code 210 utilizing a personal scanning device 162 in order to update the COC record within the database 132. This individual may then deliver the item to another individual or the recipient/patient 166. Additional entries may be made during further transfers and/or administration of the item.

In general, the correlation module 240 is operative to identify an appropriate COC record by either or both of the codes of the bar code 210 and RFID code 220. It will be appreciated that in further arrangements, the correlation module may be operative to correlate third or fourth codes associated with further identification elements. In this regard, it will be appreciated that the presented systems may be utilized with multiple different machine reading modalities.

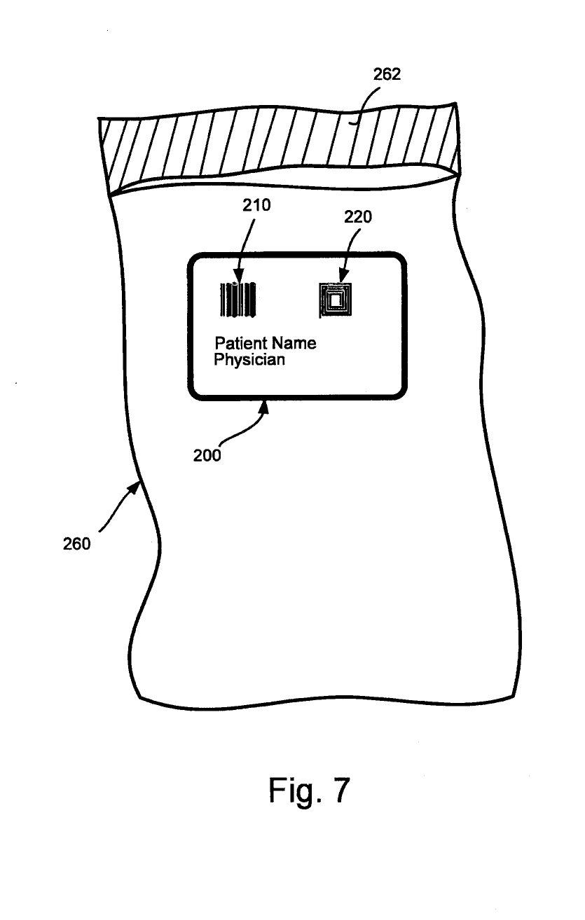

It has been further recognized by the inventor that, while the ability to generate a tag 200 having at least first and second identification elements thereon provides numerous benefits, the ability to attach such a multiple element identification tag to items is somewhat limited. Specifically, it has been recognized that items transported and tracked in many settings come in multiple different form factors. For instance, such items may be as varied as syringes, pill bottles, loose pills, etc. Accordingly, not all of these items provide a ready means for attaching the multi-element identification tag 200. According to another aspect, provided herein is an identification container as illustrated in FIG. 7. This identification container 260 is represented in the current embodiment as a flexible bag (e.g., plastic bag) having three closed ends and one open end that collectively define an interior area. In this arrangement, the tag 200 may be attached to an outside surface of the container 260, and an item for which a COC record is desired may be disposed within the interior of the container. In this arrangement, items having multiple different form factors may be conveniently transported through the system. Further, to ensure that the items remain within the container 260, the present container includes a sealable flap 262 that has a peel and release liner that may be removed from the flap 262 to expose an adhesive surface which may then be adhered to the front surface of the bag thereby sealing an item within the interior of the container 260. Though discussed primarily in relation to a flexible container, it will be appreciated that other containers may be utilized. For instance, rigid containers such as boxes or capsules may be utilized as well. Further, each of these containers may be sealed such that opening of the container breaks a seal or otherwise shows evidence of tampering.

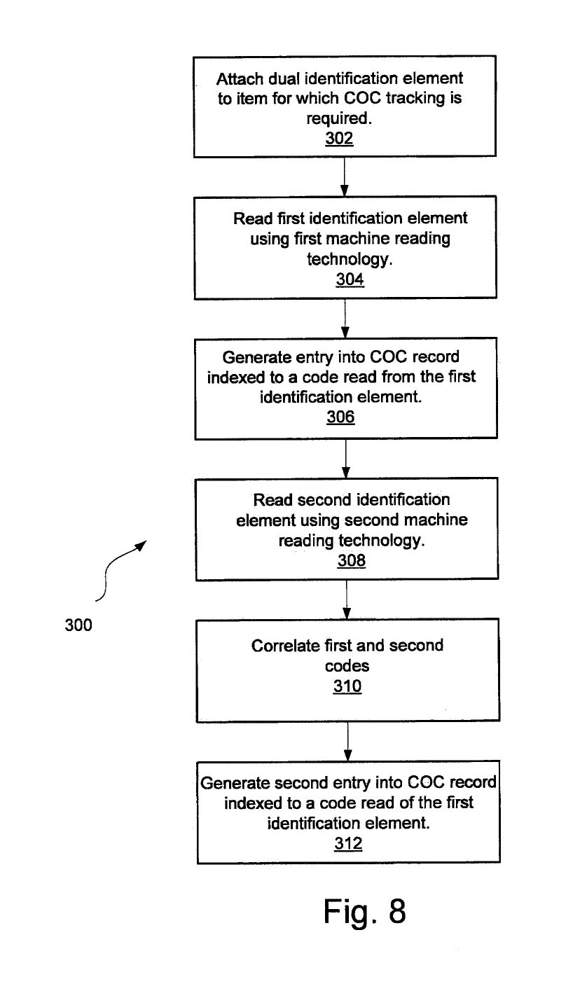

FIG. 8 illustrates a process 300 for use with a dual identification chain of custody tracking system. The method includes attaching 302 a dual identification tag having first and second machine readable identification elements to an item or container. Once attached to the item or container, the first machine readable identification tag is read 304 utilizing a first machine reading technology. Data from the first reading 304 is stored 306 as an entry in a COC record. Specifically, data from the first reading is indexed to a first code associated to the first machine readable identification tag. During transport, the second machine readable identification tag is read 308 by a second machine reading technology (e.g., RFID). Data from reading the second identification tag is then correlated 310 to the code of the first identification tag, and an additional entry is stored 312 to the COC record that is indexed to the first code.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, within the scope of the present invention. The embodiments described hereinabove are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. An identification container for use in transporting items in chain of custody tracking, comprising:
a body having an interior area sized to receive an item, wherein the item may be secured within the interior area;
a first machine readable identification tag attached to an external surface of said body, wherein said first machine readable identification tag includes a first code identifying the first machine readable identification tag, wherein said first code is readable by a first reading device using a first machine reading technology;
a second machine readable identification tag attached to said external surface of said body, wherein said second machine readable identification tag includes a second code identifying said second machine readable identification tag and wherein the first code of the first machine readable identification tag is derivable from the second code, wherein said code of said second tag is readable by a second reading device using a second machine reading technology, wherein said first and second machine reading technologies are different.

2. The apparatus of claim 1, wherein said first machine readable tag consists of a machine readable identification code.

3. The apparatus of claim 2, wherein said first machine readable tag is a bar code and wherein the first machine reading technology comprises a barcode scanner.

4. The apparatus of claim 2, wherein said second machine readable tag comprises a non-volatile electronic memory having electronically stored information.

5. The apparatus of claim 4, wherein said electronically stored information includes said first code and said second code.

6. The apparatus of claim 5, wherein said second machine readable identification tag is an radio frequency identification (RFID) tag and wherein said second machine readable technology comprises an RFID interrogator.

7. (canceled)

8. The apparatus of claim 6, wherein said second code includes at least first and second fields, wherein at least one field includes said first code.

9. The apparatus of claim 1, wherein said body comprises:
a bag having an interior space, wherein said bag includes an open end and three closed ends.

10. The apparatus of claim 9, wherein said bag further comprises:
a sealing flap adapted to adhesively close said open end.

11. A method for use in generating a chain of custody record for an item transported in a hospital setting, comprising:
inserting an item in an identification container having a first machine readable identification tag and a second machine readable identification tag, wherein said first and second machine readable identification tags are adapted to be read by first and second different machine reading technologies;
reading the first machine readable identification tag using a first machine reading technology;
storing a first transaction record to a database record indexed to a first code associated with the first machine readable identification tag;
reading the second machine readable identification tag using a second machine reading technology, wherein reading the second machine readable identification tag identifies a second code associated with the second machine readable identification tag;
based on said second code, identifying said first code of said first identification tag and storing a second transaction record to the database record indexed to the first code associated with the first machine readable identification tag.

12. The method of claim 11, wherein reading the first machine readable identification tag comprises reading a bar code using a bar code scanner.

13. The method of claim 12, wherein reading the second machine readable identification tag comprises reading an RFID tag using an RFID interrogator.

14. The method of claim 13, wherein reading the RFID tag comprises reading the RFID tag using the RFID interrogator wherein the RFID interrogator is integrated into an automated delivery system.

15. The method of claim 14, wherein the RFID interrogator is adapted to read the RFID tag at least once while the identification container moves between an origination location of the automated delivery system and a destination location of the automated delivery system.

16. The method of claim 15, wherein storing the second transaction record comprises:
storing a location of the identification container when the RFID tag is read by the RFID interrogator.

17. The method of claim 16, wherein storing the second transaction record comprises:
storing a time when the RFID tag is read by the RFID interrogator.

18. The method of claim 15, further comprising:
after delivery to the destination location of the automated delivery system, reading the first machine readable identification tag using the first machine reading technology;
storing a third transaction record to a database record indexed to a first code associated with the first machine readable identification tag.

19. The method of claim 11, wherein inserting the item in the identification container comprises disposing a pharmaceutical item in the container, wherein reading the first machine readable identification tag is performed at a pharmacy location;

20. The method of claim 19, further comprising;
depositing the identification container with an automated delivery system, wherein reading the second machine readable identification device is performed by the second machine reading technology incorporated into the automated delivery device.

21. The method of claim 19, wherein depositing comprises depositing the identification container in a pneumatic carrier of a pneumatic tube system.

22.-33. (canceled)
